(19) United States
(12) Patent Application Publication
(10) Pub. No.: US 2019/0103666 A1
(43) Pub. Date: Apr. 4, 2019

(54) Mountable Antenna Fabrication and Integration Methods

(71) Applicant: Phazr, Inc., Allen, TX (US)

(72) Inventor: Sidharth Balasubramanian, Garland, TX (US)

(21) Appl. No.: 15/723,108

(22) Filed: Oct. 2, 2017

(51) Int. Cl. H01Q 1/38; H01Q 1/48

(52) U.S. Cl. CPC H01Q 1/38; H01Q 1/48

(57) ABSTRACT

A method for fabricating a printed circuit board (PCB) antenna includes fabricating a first unit, wherein fabricating the first unit comprises forming a first dielectric substrate layer and forming one or more first radiating elements disposed on the first dielectric substrate layer. The method includes fabricating a second unit, wherein fabricating the second unit comprises forming a ground plane layer, forming a second dielectric substrate layer disposed on the ground plane layer and forming antenna feed lines disposed on the second dielectric substrate layer. The method includes integrating the first unit and the second unit by placing the first dielectric substrate layer on the antenna feed lines.

### TECHNICAL FIELD

This application relates generally to wireless communications, and more specifically to antenna fabrication and integration methods.

### BACKGROUND

Antennas are widely used in wireless applications. Due to their low profile and integration amenability, planar antennas are easily made to conform to a host surface. Also, the planar antenna can have several lateral geometries, including and not limited to circular, rectangular or triangular geometry.

A planar antenna (e.g., patch antenna) includes a base conductor layer (the ground plane), a dielectric spacer (the substrate) and a radiating antenna element or layer (the patch). A feed line (e.g., micro-strip line or coaxial line) electromagnetically connects the radiating element and the ground plane to a transmitter and/or a receiver.

Non-planar antennas including multi-layer patches comprise more layers that enhance radiation characteristics, such as gain, bandwidth, beamwidth and efficiencies.

An antenna is typically integrated with a radio interface. According to one existing method, an antenna may be built as a separate unit which is physically connected to a radio interface via cables or connectors. An advantage of building the antenna as a separate unit is the physical implementations of the antenna unit and the radio interface are independent of each other. In some applications such as, for example, millimeter wave applications, integrating the antenna with the radio interface via cables and connectors results in increased interface losses exhibited at higher frequency millimeter wave band signals. Further, the use of cables and connectors results in higher costs and larger form factor.

An antenna may be printed onto a printed circuit board (PCB) to form a PCB antenna assembly, thereby allowing dense integration, reducing form factor, and lowering interface losses. However, printing the antenna onto a PCB to form a PCB antenna assembly is generally suitable in planar geometries. In non-planar geometries (e.g., multi-layer patches), via transitions in signal paths in the PCB reduces radiation efficiencies. Also, printing the antenna onto a PCB results in higher cost of production of consumer electronics because the PCB and the antenna share same material.

### SUMMARY

According to disclosed embodiments, a method for fabricating a printed circuit board (PCB) antenna includes fabricating a first unit, wherein fabricating the first unit comprises forming a first dielectric substrate layer and forming one or more first radiating elements disposed on the first dielectric substrate layer. The method includes fabricating a second unit, wherein fabricating the second unit comprises forming a ground plane layer, forming a second dielectric substrate layer disposed on the ground plane layer and forming antenna feed lines disposed on the second dielectric substrate layer. The method includes integrating the first unit and the second unit by placing the first dielectric substrate layer on the antenna feed lines.

According to disclosed embodiments, a method for fabricating a printed circuit board (PCB) antenna includes fabricating a first unit, wherein fabricating the first unit comprises forming a first dielectric substrate layer, forming one or more first radiating elements disposed on a first side of the first dielectric substrate layer, and forming antenna feed lines disposed on a second side of the first dielectric substrate layer. The method includes fabricating a second unit, wherein fabricating the second unit comprises forming a ground plane layer and forming a second dielectric substrate layer disposed on the ground plane layer. The method includes integrating the first unit and the second unit by placing the antenna feed lines on the second dielectric substrate.

According to disclosed embodiments, the feed lines may be electromagnetically or electrically connected to the radiating elements and to the ground plane. The radiating elements and the ground plane are comprised of a conductive material.

In one aspect, the radiating elements and the ground plane are each formed on separate substrates of a multi-layer printed circuit board (PCB). The substrates are stacked substantially vertically.

According to some disclosed embodiments, the radiating elements are sized to operate in any desired frequency bands, including 24-60 GHz frequency band and sub-7 GHz range frequency band.

### BRIEF DESCRIPTION OF THE DRAWINGS

Reference is now made to the following descriptions in conjunction with the accompanying drawings, in which:

FIGS. 1A and 1B illustrate a PCB antenna fabrication and integration according to disclosed embodiments;

FIGS. 2A and 2B illustrate a PCB antenna fabrication and integration according to other disclosed embodiments;

FIG. 3 illustrates an exemplary PCB antenna;

FIGS. 4 and 5 illustrate a multi-layer antenna fabrication and integration according to disclosed embodiments; and

FIG. 6 is a method flow diagram according to disclosed embodiments.

### DETAILED DESCRIPTION

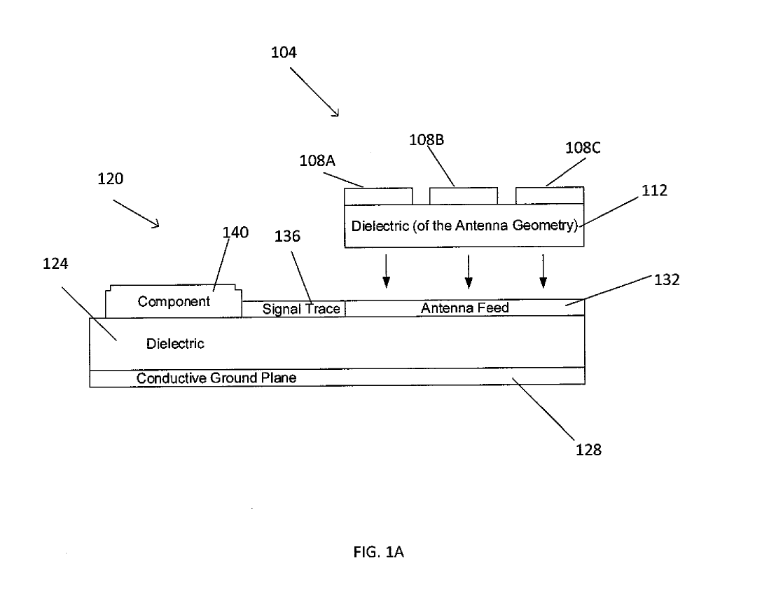

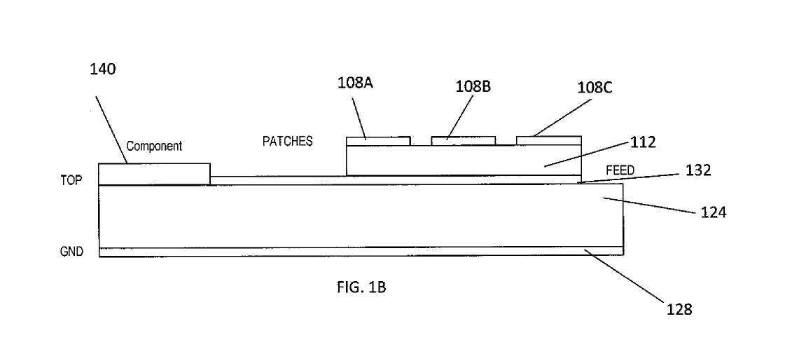

FIG. 1A illustrates a antenna fabrication and integration according to disclosed embodiments. A first unit 104 is fabricated. The first unit 104 includes radiating antenna elements 108A, 108B, 108C that are formed on a first die-electric substrate 112.

Next, a second unit 120 is fabricated. The second unit 120 is a PCB which includes a second die-electric substrate 124 formed on a ground plane 128. Antenna feed lines 132 and signal traces 136 are formed on the second die-electric substrate 124. The antenna feed lines 132 and the signal traces 136 are separated from the ground plane 128 by the second die-electric substrate 124. Various components 140 (e.g., transmitters, receivers, integrated circuits, etc.) are mounted on the second die-electric substrate 124. The components 140 are electrically connected to the feed lines 132 via the signal trace 136. The signal trace 136 may be galvanically connected to the feed lines 132.

Next, the first unit 104 is integrated with the second unit 120 by placing the first die-electric substrate 112 on the antenna feed lines 132. As an example, the integration of the first unit 104 with the second unit 120 is illustrated by three arrows. FIG. 1B illustrates the integrated PCB antenna assembly after the integration of the first and second units.

The radiating antenna elements 108A, 108B and 108C are separated from the antenna feed lines 132 by the first die-electric substrate 108, while the antenna feed lines 132 are separated from the ground plane 128 by the second die-electric substrate 124.

Referring to FIGS. 1A and 1B, the radiating elements 108A, 108B, 108C, the first die-electric substrate 112, the feed lines 132, the second die-electric substrate 124 and the ground plane 128 are stacked substantially vertically. The radiating elements 108 may be comprised of a conducting material (e.g., copper or gold) used in conventional antennas. Similarly, the ground plane 128 may be comprised of a conducting material. Dielectric substrates 112 and 124 may be comprised of a dielectric material having low loss and small variation in permittivity with temperature.

According to some disclosed embodiment, the elements 108A, 108B, 108C and the ground plane 128 are stacked substantially vertically and are attached to the adjacent substrates with or without any air gap. For example, an air gap can be formed when placing the first unit 104 on the second unit 120.

According to disclosed embodiments, the antenna is excited separately by the feed lines 132. The feed lines 132 may include a horizontal feed line and a vertical feed line (not shown in FIG. 1A). By exciting the antenna separately in two directions, two linear orthogonal polarizations are implemented on the radiating elements.

According to disclosed embodiments, the feed lines 132 may comprise coplanar lines, microstrip lines, embedded striplines or wave guides which couple the radiating elements 108A, 108B, 108C and the ground plane 128.

Although the exemplary antenna is illustrated in FIGS. 1A and 1B as comprising three radiating elements, some embodiments according to the principles of the invention may be implemented with more than three radiating elements or less than three radiating elements. The radiating elements may have the same size. In some embodiments, however, the radiating elements may be constructed such that their sizes vary. Thus, for example, the surface area or thickness of a first radiating element may be greater than the surface area or width of a second radiating element.

According to some disclosed embodiments, the radiating elements 108A, 108B and 108C have circular geometries. In other disclosed embodiments, the radiating elements 108A, 108B and 108C may have other geometries such as, for example, rectangular or square.

According to some disclosed embodiments, the antenna fabricated in accordance with the aforementioned methods of FIGS. 1A and 1B is configured to operate at any desired frequency bands including but not limited to millimeter wave frequency bands.

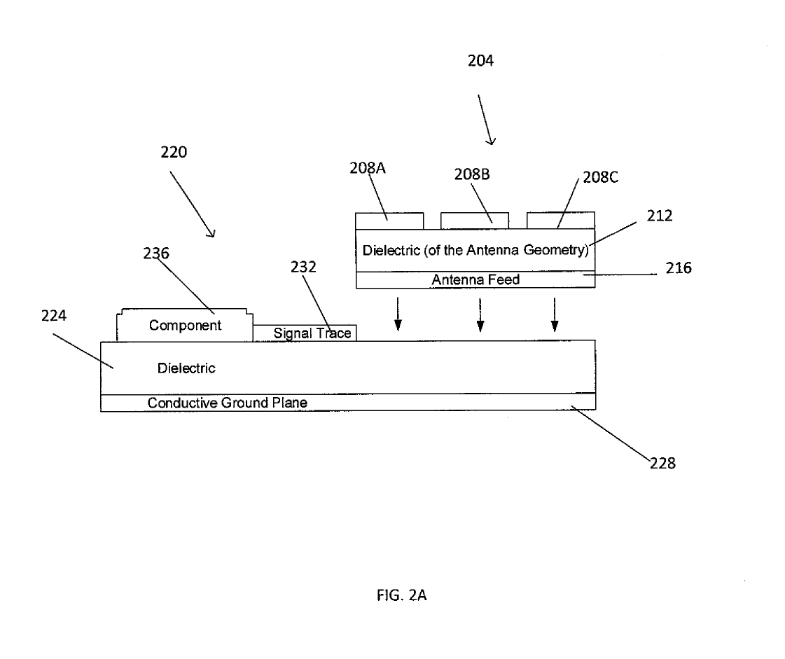

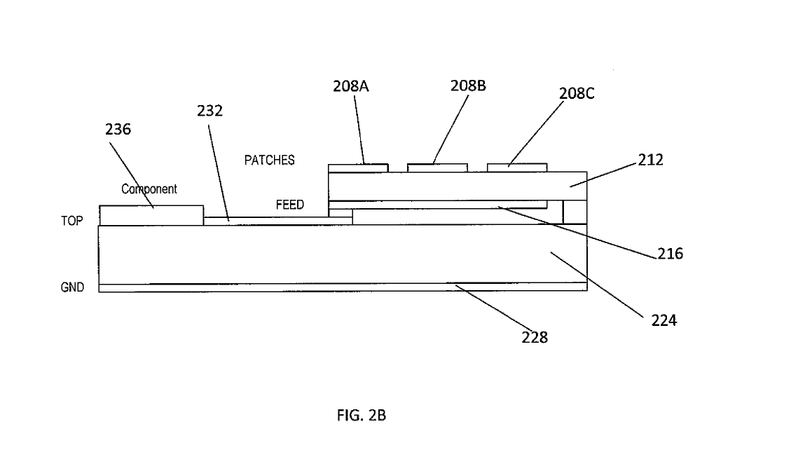

FIG. 2A illustrates a patch antenna fabrication and integration according to other disclosed embodiments. A first unit 204 is fabricated. The first unit 204 includes one or more radiating antenna elements or patches 208A, 208B, 208C which are formed on one side of first die-electric substrate 212. Antenna feed lines 216 are formed on the other side of the first die-electric substrate 212.

Next, a second unit 220 is fabricated. The second unit 220 is a PCB which includes a second die-electric substrate 224 formed on a ground plane 228. Signal traces 232 are formed on the second die-electric substrate 224. The signal traces 232 are separated from the ground plane 228 by the second die-electric substrate 224. Various components 236 (e.g., transmitters, receivers, integrated circuits, etc.) are mounted on the second die-electric substrate 224.

Next, the first unit 204 is integrated with the second unit 220 by placing the antenna feed lines 216 on the second die-electric substrate 224. After the integration of the first unit 204 with the second unit 220, the radiating antenna elements 208A, 208B and 208C are separated from the antenna feed lines 216 by the first die-electric substrate 212, while the antenna feed lines 216 are separated from the ground plane 228 by the second die-electric substrate 224.

According to disclosed embodiments, the patch antenna fabricated in accordance with the aforementioned methods of FIGS. 2A and 2B is configured to operate at millimeter wave frequency bands.

According to disclosed embodiments, the first unit may be attached to the second unit using resin bonding or solder bonds. The signal traces may be galvanically connected to the feed lines using a solder bump or by coupling. FIG. 2B illustrates a PCB antenna assembly following the integration. The feed mechanism galvanically connects signal and ground using G-S-G or G-S-S-G connections.

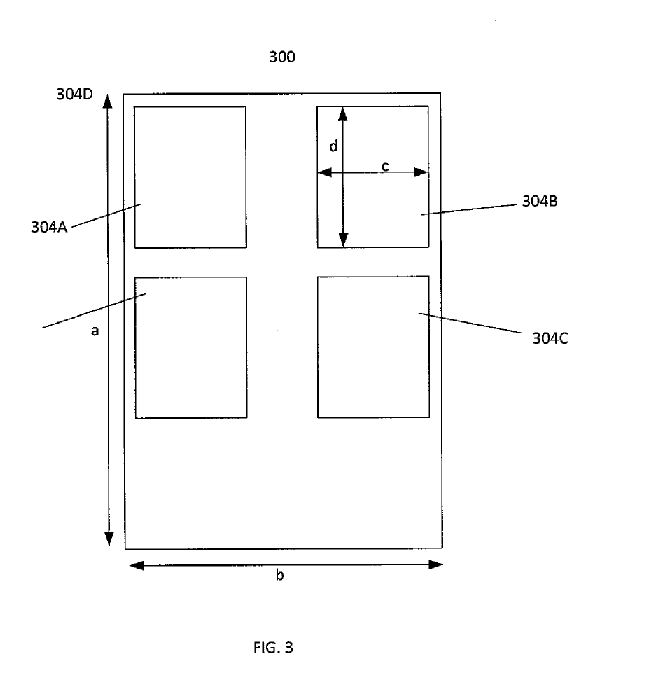

The antenna fabrication and integration methods disclosed herein have numerous advantages. Referring to FIG. 3, an exemplary PCB antenna assembly 300 fabricated in accordance with disclosed embodiments includes four antennas 304A, 304B, 304C and 304D. In the exemplary embodiment, the size of the PCB 300 is a*b, where a and b are length and width, respectively. The total size of the 4 antennas is c*d*n, where c, d, and n are length, width and number, respectively. Consider, for example, the antennas occupy 30% of the PCB area (i.e., c*d*n=(⅓)a*b). If the cost of the antenna material is A_{c} and the cost of PCB material is P_{c}, the material cost for an antenna integration according to existing method is a*b*A_{c}. In contrast, according to disclosed embodiments, the material cost of the PCB is a*b*P_{c} and the material cost of the antenna is c*d*n*A_{c}=0.3a*b*A_{c}. Thus, the total material cost according to disclosed embodiments is a*b*(P_{c}+0.3 A_{c}), which is significantly less than a*b*A_{c} because P_{c} is generally 0.1 A_{c}. Thus, the antenna fabrication and integration methods according to disclosed embodiments enable use of different materials to aid in the performance enhancement while controlling development costs.

Referring to FIGS. 1A and 2A, the fabrication of the first unit (i.e., antenna) in a separate step and independent of the second unit (i.e., PCB) enables band-independent PCB fabrication and rapid prototyping for multiple bands and standards. Also, the vertical dimensions of the antenna present a cost-effective additional degree of design freedom which enables the patch antenna to exhibit a wider bandwidth. Also, the thickness of the first die-electric substrates in FIGS. 1 and 2 limits propagation of millimeter waves beyond the edges of the antenna, thus improving inter-antenna isolation. Also, the fabrication of the feed lines on the same layer as the components in some disclosed embodiments eliminates transitions in millimeter wave paths, thereby improving radiation efficiency.

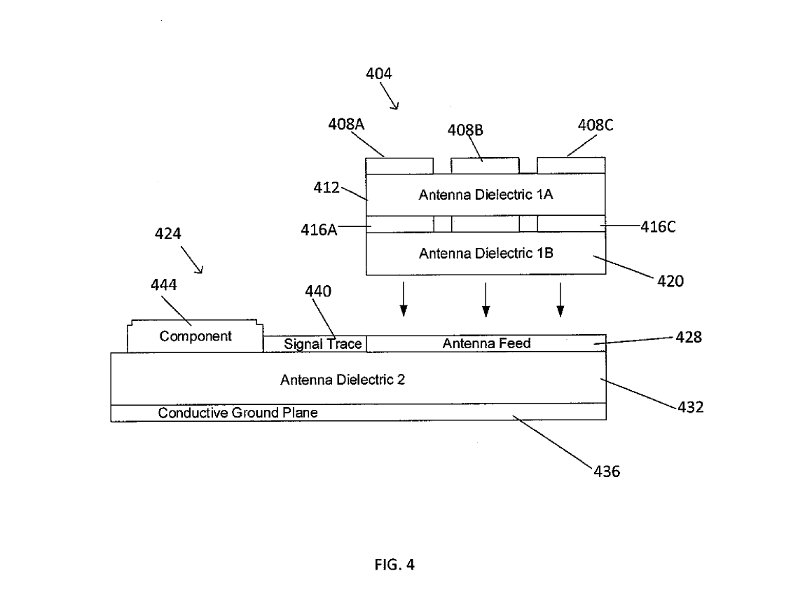

FIG. 4 illustrates a multi-layer patch antenna fabrication and integration according to disclosed embodiments. A first unit 404 is fabricated. The first unit 404 includes radiating antenna elements or patches 408A, 408B, 408C which are formed on a first die-electric substrate 412. The first unit 404 also includes radiating antenna elements 416A, 416B, 416C formed between the first die-electric substrate 412 and a second die-electric substrate 420. Thus, the first unit 404 comprises two layers of radiating elements, a first layer comprising radiating elements 408A-408C and a second layer comprising radiating elements 416A-416C.

Next, a second unit 424 is fabricated. The second unit 424 is a PCB which includes a third die-electric substrate 432 formed on a ground plane 436. Antenna feed lines 428 and signal traces 440 are formed on the third die-electric substrate 432. The antenna feed lines 428 and the signal traces 440 are separated from the ground plane 436 by the third die-electric substrate 432. Various components 444 (e.g., transmitters, receivers, integrated circuits, etc.) are mounted on the third die-electric substrate 432. The components 444 are electrically connected to the feed lines 428 via the signal trace 440. The signal trace 440 may be galvanically connected to the feed lines 428.

Next, the first unit 404 is integrated with the second unit 424 by placing the die-electric substrate 420 on the antenna feed lines 428. After the integration of the first unit 404 with the second unit 424, the PCB antenna assembly is built. The radiating antenna elements 408A, 408B and 408C are separated from the radiating elements 416A, 416B, 416C by the die-electric substrate 412, and the radiating elements 416A, 416B, 416C are separated from the feed lines 428 by the die-electric substrate 420. The radiating elements are also separated from the ground plane 436 by the die-electric substrate 424. Although the exemplary embodiment of FIG. 4 illustrates only two layers of radiating elements, other embodiments may have more than two layers of radiating elements.

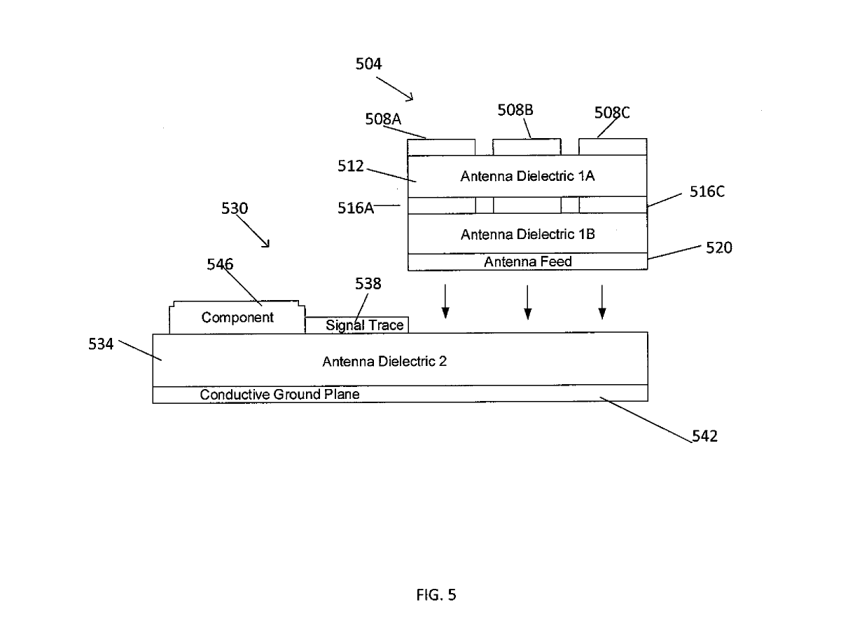

FIG. 5 illustrates a multi-layer antenna fabrication and integration method according to other disclosed embodiments. A first unit 504 is fabricated. The first unit 504 includes radiating antenna elements or patches 508A, 508B, 508C which are formed on a first die-electric substrate 512. The first unit 504 also includes radiating elements 516A, 516B, 516C formed between the first die-electric substrate 512 and one side of a second die-electric substrate 520. Thus, the first unit 504 comprises two layers of radiating elements, a first layer comprising radiating elements 508A-508C and a second layer comprising radiating elements 516A-516C. Antenna feed lines 520 are formed on another side of the second die-electric substrate 520.

Next, a second unit 530 is fabricated. The second unit 530 is a PCB which includes a third die-electric substrate 534 formed on a ground plane 542. Signal traces 538 are formed on the third die-electric substrate 534. The signal traces 538 are separated from the ground plane 542 by the third die-electric substrate 534. Various components 546 (e.g., transmitters, receivers, integrated circuits, etc.) are mounted on the third die-electric substrate 534.

Next, the PCB antenna assembly is built by integrating the first unit 504 with the second unit 530. The first unit 504 is integrated with the second unit by placing the antenna feed lines 520 on the third die-electric substrate 534. Although the exemplary embodiment of FIG. 5 illustrates only two layers of radiating elements, other embodiments may have more than two layers of radiating elements.

According to disclosed embodiments, the first unit 504 may be attached to the second unit 530 using resin bonding or solder bonds. The signal traces 538 may be galvanically connected to the feed lines 524 using a solder bump or electromagnetically by coupling with or without air gap.

According to the principles of the invention, the radiating elements 504A-504C, 516A-516C may be any geometry. While circular patches may be utilized in some applications, the invention is not limited to such shapes. Other solid or semi-solid Euclidean structures, including ellipse, oval, polygon, semicircle or other shapes may be utilized and are intended to fall within the scope of the invention.

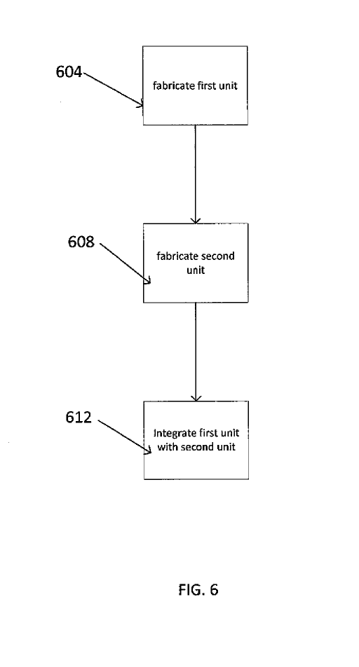

FIG. 6 is a flow diagram of a method for fabricating and integrating a PCB patch antenna assembly in accordance with disclosed embodiments. In a step 604, a first unit is assembled in accordance with the methods described above. In a step 608, a second unit is assembled in accordance with the methods described above. In a step 612, the first unit is integrated with the second unit to form the PCB patch antenna assembly.

Those skilled in the art will recognize that, for simplicity and clarity, the full structure and operation of all systems suitable for use with the present disclosure is not being depicted or described herein. Instead, only so much of systems as is unique to the present disclosure or necessary for an understanding of the present disclosure is depicted and described. The remainder of the construction and operation of the disclosed systems may conform to any of the various current implementations and practices known in the art.

Of course, those of skill in the art will recognize that, unless specifically indicated or required by the sequence of operations, certain steps in the processes described above may be omitted, performed concurrently or sequentially, or performed in a different order. Further, no component, element, or process should be considered essential to any specific claimed embodiment, and each of the components, elements, or processes can be combined in still other embodiments.

Those skilled in the art to which this application relates will appreciate that other and further additions, deletions, substitutions and modifications may be made to the described embodiments.

What is claimed is:

1. A method for integrating an antenna onto a printed circuit board (PCB), comprising:
fabricating a first unit, wherein fabricating the first unit comprises:
forming a first dielectric substrate layer;
forming one or more first radiating elements disposed on the first dielectric substrate layer;
fabricating a second unit, wherein fabricating the second unit comprises:
forming a ground plane layer;
forming a second dielectric substrate layer disposed on the ground plane layer;
forming antenna feed lines disposed on the second dielectric substrate layer;
integrating the first unit and the second unit by placing the first dielectric substrate layer on the antenna feed lines.

2. The method of claim 1, further comprising:
mounting one or more components on the second dielectric substrate;
forming signal traces on the second dielectric substrate layer;
electrically connecting the components to the antenna feed lines via the signal traces.

3. The method of claim 1, further comprising electrically connecting the antenna feed lines to the first radiating elements and to the ground plane.

4. The method of claim 1, wherein the first radiating elements are comprised of a conductive material.

5. The method of claim 1, wherein the ground plane is comprised of a conductive material.

6. The method of claim 1, further comprising:
forming a third dielectric substrate layer disposed on the first radiating elements;
forming one or more second radiating elements disposed on the third dielectric substrate layer.

7. The method of claim 1, wherein the radiating elements, the first dielectric substrate, the antenna feed lines, the second dielectric substrate are stacked substantially vertically above the ground plane.

8. The method of claim 1, wherein the radiating elements, the first and second dielectric substrates and the ground plane are each formed on separate substrates of a multi-layer printed circuit board (PCB), and wherein the substrates are stacked substantially vertically.

9. The method of claim 1, wherein the radiating elements are sized to operate in the 24-60 GHz frequency band.

10. The method of claim 1, wherein the radiating elements are sized to operate in the sub-6 GHz frequency band.

11. A method for fabricating a printed circuit board (PCB) antenna, comprising:
fabricating a first unit, wherein fabricating the first unit comprises:
forming a first dielectric substrate layer;
forming one or more first radiating elements disposed on a first side of the first dielectric substrate layer;
forming antenna feed lines disposed on a second side of the first dielectric substrate layer;
fabricating a second unit, wherein fabricating the second unit comprises:
forming a ground plane layer;
forming a second dielectric substrate layer disposed on the ground plane layer;
integrating the first unit and the second unit by placing the antenna feed lines on the second dielectric substrate.

12. The method of claim 11, further comprising:
mounting one or more components on the second dielectric substrate;
forming signal traces on the second dielectric substrate layer;
electrically connecting the components to the antenna feed lines via the signal traces.

13. The method of claim 11, further comprising electrically connecting the antenna feed lines to the first radiating elements and to the ground plane.

14. The method of claim 11, wherein the first radiating elements are comprised of a conductive material.

15. The method of claim 11, wherein the ground plane is comprised of a conductive material.

16. The method of claim 11, wherein the radiating elements are sized to operate in the 24-60 GHz frequency band.

17. The method of claim 11, wherein the radiating elements are sized to operate in the sub-6 GHz frequency band.

18. The method of claim 11, wherein the radiating elements are sized to operate in the millimeter wave frequency bands.

19. The method of claim 1, wherein the radiating elements are sized to operate in the millimeter wave frequency band.
